(19) United States
(12) Patent Application Publication
(10) Pub. No.: US 2010/0153157 A1
(43) Pub. Date: Jun. 17, 2010

(54) METHOD AND SYSTEM FOR PROVIDING NETWORK RESOURCE GROWTH MANAGEMENT

(75) Inventors: Brian T. Wade, Flemington, NJ (US); Sambasiva R. Bhatta, Tampa, FL (US); Murali Krishnaswamy, Piscataway, NJ (US); Darshan Mehta, Howell, NJ (US); Jie Qian, Center Valley, PA (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/332,887

(22) Filed: Dec. 11, 2008

(51) Int. Cl. G06Q 10/00; G06Q 50/00

(52) U.S. Cl. 705/8; 705/10

(57) ABSTRACT

An approach is provided for network resource growth management. Utilization of a network resource that is hierarchically associated with one or more other network resources is determined. If the utilization exceeds a first predetermined threshold, a growth notification is triggered. The growth notification specifies additional network resources required to modify the utilization of the network resource according to a second predetermined threshold.

### BACKGROUND INFORMATION

Modem communication networks are growing in size and complexity. Unfortunately, as the number of consumers increase and the sophistication of services continue to evolve, the performance of these networks can degrade, in part, from link and pathway congestion. As such, service providers typically engage in network resource growth management in order to determine the most cost-effective way to provision new and/or existing resources to support current and impending volumes of network traffic. For instance, resource growth management may entail determining when and where to add bandwidth, when and where to expand routing or switching capacity, and the like. In fact, given the highly competitive nature of the telecommunications industry, service providers are now relying, more than ever, on network availability and quality of service as key differentiators to delivering voice, data, and video services. Thus, the ability to dynamically manage the growth of network resources to meet these needs is becoming an ever critical aspect of business for service providers.

Therefore, there is a need for an approach that can effectively and efficiently facilitate network resource growth management.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of network resource growth management, according to an exemplary embodiment;

FIG. 2 is a diagram of a network resource manager, according to an exemplary embodiment;

FIG. 3 is a network resource utilization plot for establishing threshold trigger points for dynamically generating growth notifications, according to exemplary embodiments;

FIG. 4 is a flowchart of a process for managing network resources based on dynamically generated growth notifications, according to an exemplary embodiment;

FIG. 5 is a flowchart of a process for withdrawing growth notifications, according to an exemplary embodiment;

FIG. 6 is a diagram of an illustrative growth notification, according to an exemplary embodiment; and

FIG. 7 is a diagram of a computer system that can be used to implement various exemplary embodiments.

### DESCRIPTION OF THE PREFERRED EMBODIMENT

A preferred apparatus, method, and software for network resource growth management are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to managing the growth of network components (e.g., network interface ports, cards, shelves, elements, and groups of elements) that are arranged hierarchically, it is contemplated that various exemplary embodiments are also applicable to managing the growth of other suitable or equivalent network resources and relational structures.

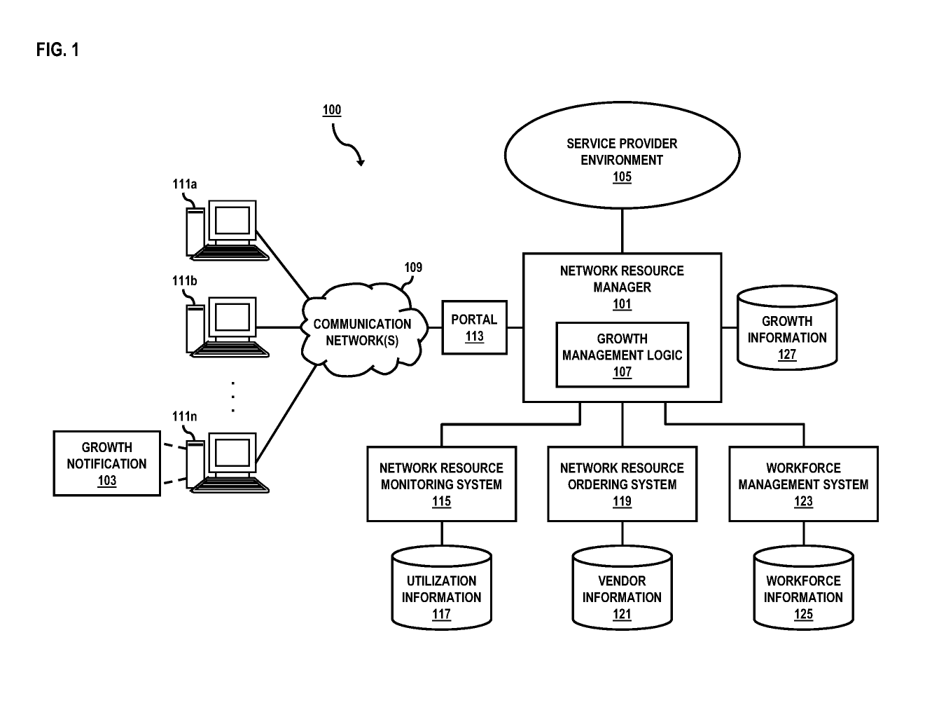

FIG. 1 is a diagram of a system capable of network resource growth management, according to an exemplary embodiment. For the purposes of illustration, system 100 is described with respect to network resource manager 101 configured to dynamically generate growth notifications (e.g., growth notification 103) relating to the potential exhaustion of network resources provisioned to service provider environment 105. In this way, growth notifications may be utilized to trigger the ordering (or procuring) and replenishment of additional network resources capable of preventing the actual exhaustion of (or maintaining a relaxed state for) the network resources provisioned to service provider environment 105. By way of example, service provider environment 105 may correspond to the infrastructure of a service provider in support of any type of service, e.g., data, voice, and/or video services. While specific reference will be made thereto, service provider environment 105 may correspond to any environment conducive to resource growth management, such as a product manufacturing environment, a professional staffing environment, a resource allocation environment, etc. As such, it is contemplated that system 100 may embody many forms and include multiple and/or alternative components and facilities.

It is noted that network service providers (or carriers) are invariably presented with various infrastructure issues pertaining to the exhaustion of network resources in response to the provisioning of new customer accounts and the inauguration of new, more process intensive services. Not responding adequately to these issues can inevitably lead to the degradation of network performance, loss of service, or, worst case, the migration of customers. Furthermore, as the infrastructure of a service provider geographically expands and grows more technologically advanced, it is becoming a rather complex and onerous task to ensure and supply the right amount of network resource capacity, in the right form, in the right place, all within the right time frame. Thus, given this prevalence, geographic dispersion, and continual expansion of modern networks, it is increasingly more challenging for service providers to delicately predict and adequately respond to the network resource needs before quality of service issues arise. Moreover, these tasks are exacerbated by the inherently variable, sometimes unforeseeable nature of the supply chains for the replenishment of network resources for service-oriented environments.

Traditionally, network service providers have attempted to retroactively respond to the exhaustion of network resources or at least manually forecast such exhaustion using “on-the-fly,” intuition-based methods or other information techniques, such as averaging network growth over a recent past to predict and respond with network resources for a narrow future. In other instances, network service providers have continually expanded network capacity without regard to need and with the assumption that sufficient monetary resources are, or at least will be, available. As such, network resources may be inefficiently and/or inconsistently managed, which becomes more acute when comparing the performance of a network from one region to another, as well as given the fact that more and more network resources are becoming interdependent upon one another. Further, such techniques lack an objective basis that can be dynamically assessed and improved. To remain competitive, however, service providers must be able to provide consistent, high quality service across their footprint, as well as continually find new ways to forecast and profitably respond to the growing demands upon their infrastructure.

Therefore, the approach according to certain embodiments of system 100 stems from the recognition that objective, dynamic network resource growth management tools utilizing information corresponding to the interdependence and utilization of existing network resources, lead-times for obtaining and provisioning new network resources, and forecasted growth of new customers and services (i.e., utilization of the network resources), provide an effective technique to systematically forecast, prioritize, and optimize the replenishment of new network resources in the right amount, form, place, and time.

As shown, system 100 includes network resource manager 101 configured to determine when, where, how much, and what type of new network capacity, i.e., network resources, are required in order to prevent the exhaustion of network resources provisioned to service provider environment 105. That is, network resource manager 101 may dynamically generate growth notifications based on the comparison of utilization of one or more network resources (which may be hierarchically associated with one or more other network resources) with a first predefined threshold. Thus, if the utilization exceeds the first predefined threshold, a growth notification may be generated to specify additional network resources capable of modifying (e.g., relaxing) the utilization of the one or more network resources in accordance with a second predetermined threshold. For example, a network element, such as a routing cabinet, may include a number of spaces for supporting a number of shelves that are, in turn, capable of supporting a number of network interface cards (or cards), which are individually defined by a number of network interface ports (or ports). In this manner, each of these components may be considered a network resource and, thereby, may be monitored by network resource manager 101. During the monitoring process, network resource manager 101 may determine utilization of, for instance, all the ports of a card, shelf, and cabinet to determine whether additional cards, shelves, or cabinets are required to prevent the exhaustion (or overuse) of the existing ports of the cards, shelves, and cabinet. A hierarchical ordering between these network resources may be established and utilized by network resource manager 101 to optimize the addition (or replenishment) of these network resources. An exemplary hierarchical ordering may be, from a lowest level to a highest level, the ports, the cards, the shelves, and the network elements. It is noted that one or more network elements may be physically or logically grouped, such as within a central office (CO) of a service provider, and, thereby, may represent another hierarchical level (i.e., a network element group level) higher than the network elements. As such, lower level network resources may be added before higher level network resources are added. It is also noted, that once higher level network resources are added, the addition of network resources may iteratively return to adding lower level network resources before adding additional higher level network resources.

In order to implement various exemplary embodiments, network resource manager 101 may execute one or more processes, via growth management logic 107, which can dynamically account for the utilization of network resources based on one or more first predetermined thresholds. As such, network resource manager 101 may be further configured to facilitate “what if” planning based on one or more hypothetical user inputs affecting the first and/or second predetermined thresholds, as well as one or more other variable factors, e.g., utilization growth information. Since network resources may be geographically applied to certain regions of interest, growth notifications (e.g., growth notification 103) may be issued macroscopically, i.e., pertaining to a contiguous infrastructure of a service provider, or microscopically, i.e., from one region of interest to another.

According to various embodiments, network resource manager 101 may be implemented in one or more computing environments, including as a backend component (e.g., as a data server), as a middleware component (e.g., as an application server), as a front-end component (e.g., as a client computing device having a graphical user interface (GUI) or web-browsing application through which client computing devices can interact with a data server or application server), or as any combination thereof. Network resource manager 101 may be interconnected by any form or medium capable of supporting data communication, such as one or more communication networks 109, e.g., a local area network (LAN), a metropolitan area network (MAN), a wide area network (WAN), the Internet, etc. Further, communication networks 109 may embody any telephony, packet-switched, or wireless network capable of transmitting data. As such, system 100 may embody a client-server environment, a master-slave environment, a peer-to-peer environment, or any other suitable environment. Although depicted as separate entities, communication network(s) 109 may be completely or partially contained within service provider environment 105. For example, communication networks 109 may include facilities to provide for transport of packet-based and/or telephony communications within service provider environment 105.

In exemplary embodiments, service provider environment 105 may be any network (or group of networks) through which users (such as home users, business users, and the like) communicate with various service providers. As such, service provider environment 105 may include various facilities and equipment that extend from the location(s) of each user to the location(s) of each service provider in order to facilitate communications between them. For instance, service provider environment 105 may include the outside plant, the inside plant, and/or the inside wiring of a service provider. By way of example, the outside plant includes the cables, conduits, ducts, poles, and other supporting structures, as well as certain equipment items, such as load coils, repeaters, etc., of a network service provider. Namely, the outside plant includes the local loops, which are the physical connections from one or more customer premises (e.g., residential homes, commercial businesses, etc.) to the points of presence (POP) of the service provider. It is noted that the local loops may be provided over any suitable transmission medium, including twisted pair, fiber optic, coax, and the like. For example, a local loop of a conventional telephone system may comprise twisted pairs (or other wiring) that connect a demarcation point (e.g., a distribution frame, a cable head, etc.) of a customer premise to an edge (e.g., a circuit switch) of a local exchange carrier (LEC) central office (CO). The inside plant may include the fixtures, implements, machinery, and apparatuses used within one or more COs of the service provider, such as the switches, routers, broadband equipment, distribution frames, transmission equipment, power supply equipment, heat coil protectors, grounding systems, etc., of the service provider. Accordingly, the inside wiring includes the aforementioned transmission mediums as those mediums are located within a customer premise or building. The inside wiring begins at the demarcation point and extends to individual end terminals, such as one or more client computing devices 111a-111n. In this way, network resource manager 101 may be configured to manage the growth of one or more of these network resources.

It is noted that service provider environment 105 may be geographically dispersed across numerous regions or other logical divisions. As such, network resource manager 101 may be configured to monitor the utilization of, and issue growth notifications concerning, the network resources provisioned within these regions or divisions at any granularity.

As shown in FIG. 1, network resource manager 101 is implemented as a backend data server accessible to one or more client computing devices 111a-111n via a middleware application server, i.e., portal 113. Client computing devices 111a-111n interact with portal 113 via communication network(s) 109. According to one embodiment, portal 113 acts as an enterprise web portal that provides a consistent “look and feel” for access control and conducting network resource growth management operations. Such an architecture, while not necessary, enables client computing devices 111a-111n to be remotely dispersed (e.g., as by geography) from each other, as well as from network resource manager 101, yet remain in collaboration with network resource manager 101. Namely, portal 113 enables intelligent integration of and unified, real-time access to network resource manager 101. According to one embodiment, portal 113 provides one or more customized portlets (e.g., user interface components) arranged in one or more page layouts, which can be tailored to the various users and/or logical divisions (e.g., geographical regions) of service provider environment 105. Thus, users of network resource manager 101 can be provided a common set of web-based, or otherwise networked, network resource growth management applications to consistently and efficiently manage the network resources of service provider environment 105. Portal 113 may also be employed to allow users, via client computing devices 111a-111n, to perform “what if” planning based on one or more hypothetical user inputs.

According to one embodiment, system 100 includes network resource monitoring system 115 for monitoring the utilization (e.g., network traffic load at a particular point in time or over a particular period of time) of one or more network resources provisioned to service provider environment 105, as well as any other suitable network statistic governing service provider environment 105, such as network topology, quality of service, total number of subscribers, etc. Network resource monitoring system 115 may communicate with network resource manager 101 directly or via one or more networks, such as a corporate network (not illustrated) of the service provider. Accordingly, this utilization and network statistic information (aggregately referred to as utilization information) may be stored to any suitable memory, such as utilization information repository 117, a memory of network resource monitoring system 115, and/or provided to network resource manager 101 for performing one or more network resource growth management operations. In exemplary embodiments, network resource utilization may be monitored or reported as a percentage of a rated capacity, such as a burst rate, signaling rate, transmission rate, etc., of a network resource. It is noted that these capacity ratings are typically dependent upon the network resource and supporting network resource protocol(s) for which the capacity rating applies. As such, reporting network resource utilization in terms of a percentage of a rated capacity enables utilization normalization. In this manner, network resource monitoring system 115 may push (either automatically or in response to a request) certain utilization information to network resource manager 101. As such, network resource monitoring system 115 may include a communication interface (not shown) for transmitting utilization information to network resource manager 101, either “on-demand” or as the result of a predefined schedule, such as continuously or periodically. Thus, network resource monitoring system 115 is configured as an operations support system, which provides network resource manager 101 with a unified view of the utilization (or relative exhaustion) of network resources provisioned to service provider environment 105.

System 100 may also include network resource ordering system 119 for responding to growth notifications issued by network resource manager 101. Network resource ordering system 119 can communicate with network resource manager 101 directly or via one or more networks, such as a corporate network of the service provider. According to one embodiment, network resource ordering system 119 may maintain or have access to a repository of vendor information, such as vendor information repository 121. This vendor information may relate to various manufacturers and corresponding network equipment of these manufacturers that can be provisioned to service provider environment 105. The vendor information may also relate to availability parameters, costs, delivery schedules, equipment capabilities, and the like. Accordingly, vendor information repository 121 may provide a catalog of information regarding a variety of network resources, such as one or more network elements, shelves, cards, and the like. It is noted that network resource ordering system 119 may include a communication interface (not shown) configured to transmit the vendor information, either “on-demand” or as the result of a predefined schedule, such as continuously or periodically. In exemplary embodiments, this vendor information (such as availability parameters and delivery schedules) may be pushed (either automatically or in response to a request) to network resource manager 101 and, thereby, utilized in the determination of one or more lead-times for provisioning network resources to service provider environment 105. Thus, network resource ordering system 119 is configured as an operations support system, which provides network resource manager 101 with a unified view of the availability of additional network resources capable of being provisioned to service provider environment 105.

As a workforce is generally required to handle the provisioning (e.g., installation, setup, etc.) of network resources, system 100 also includes workforce management system 123 in communication with network resource manager 101, either directly or via one or more networks, such as a corporate network of the service provider. Workforce management system 123 is configured to automate the handling of work performed by a workforce of a service provider, such as the work (or tasks) generated in response to output from network resource manager 101. According to exemplary embodiments, this work may arise in response to the generation of growth notifications (e.g., growth notification 103) specifying when, where, and how much additional network resources are required to, for example, relax the utilization of existing network resources provisioned to service provider environment 105. Further, workforce management system 123 may push (either automatically or in response to a request) certain status information to network resource manager 101. For example, the status information may relate to the availability (or scheduling) of a workforce, estimated times of completion for assigned tasks, etc. In turn, network resource manager 101 may, according to exemplary embodiments, dynamically modify one or more parameters affecting the generation of growth notifications 103 based on this status information.

According to certain embodiments, workforce management system 123 may store this status information, as well as other work related information to workforce information repository 125. It is contemplated that this information may additionally (or alternatively) be stored to a memory of workforce management system 123 and/or transmitted to network resource manager 101. In this manner, workforce management system 123 can include a communication interface (not shown) configured to transmit this information to network resource manager 101, either “on-demand” or as the result of a predefined schedule, such as continuously or periodically. Network resource manager 101 may, in turn, utilize received information (or parsed data therefrom) from workforce management system 123 to dynamically generate and assign one or more lead-times for provisioning additional network resources to service provider environment 105. It is noted that network resource manager 101 may combine this information with information received from network resource ordering system 119 to further dynamically generate and assign the one or more lead-times. As such, the one or more lead-times may affect the generation of growth notifications 103 by network resource manager 101.

In general, the information stored to workforce information repository 125 may correspond to one or more members of the workforce and relate to member availability (e.g., scheduling information), skills, training, billing rate, assigned service provider environment 105 region, current geographical assignment, and employee/contractor status, as well as any other suitable workforce contingent parameter, such as work preferences, etc. Additionally, the information may also relate to installation equipment, transportation vehicles, and other workforce related network resources. These various forms of workforce related information define the availability of the workforce of a service provider to provision additional network resources to service provider environment 105. Thus, workforce management system 123 is configured as an operations support system, which provides network resource manager 101 a unified view of the workforce as it is associated with service provider environment 105.

According to exemplary embodiments, network resource manager 101 generates growth notifications 103 based on, for instance, one or more parameters, such as one or more hierarchical orderings for the network resources, one or more regions (or geographies) of interest applicable to the network resources, and/or one or more thresholds governing the utilization of the network resources, as well as other suitable parameters, e.g., quality of service expectations, service level agreements, user profiles, and the like. In turn, the one or more thresholds may be further established based on one or more lead-times for replenishing network resources, one or more rated capacities governing the utilization of network resources, and/or one or more utilization growth rates forecasting potential utilization demands on service provider environment 105. As such, these parameters may be stored to a memory (not shown) of network resource manager 101, gathered within growth information repository 127, or collected at any other suitable storage location. According to exemplary embodiments, one or more of these parameters may be provided by (or determined based on other information provided by) network resource monitoring system 115, utilization information repository 117, network resource ordering system 119, vendor information repository 121, workforce management system 123, and/or workforce information repository 125. It is noted that growth information repository 127 may also store information corresponding to the network resources provisioned to or waiting to be provisioned to service provider environment 105, such as one or more network topologies, etc. It is also noted that one or more of these parameters may be supplied by users via a client computing device, such as client computing device 111a. Further, the information stored to growth information repository 127 (or other suitable storage location of system 100) may be hierarchically ordered, such as hierarchically ordered based on the network resources of service provider environment 105 being allocated to one or more network element groups, network elements, shelves of a network element, network interface cards of a shelf, network interface ports of a network interface card, and the like.

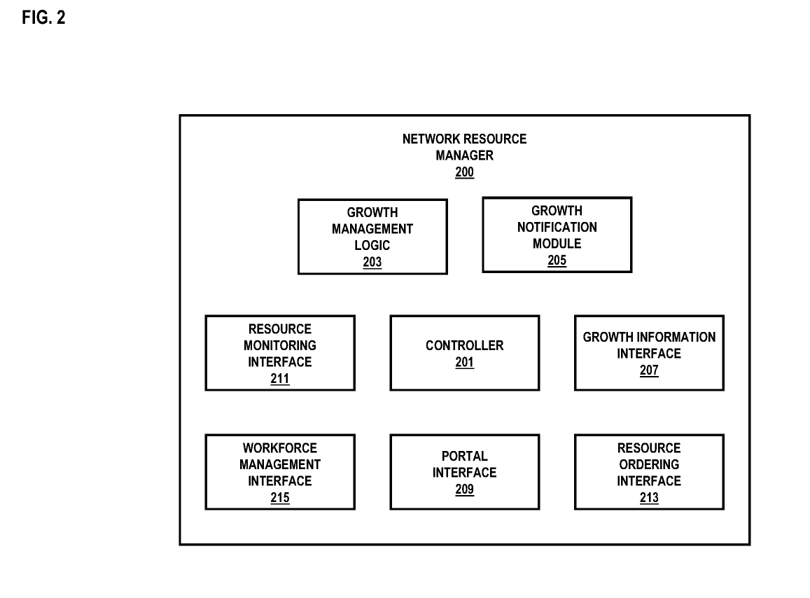

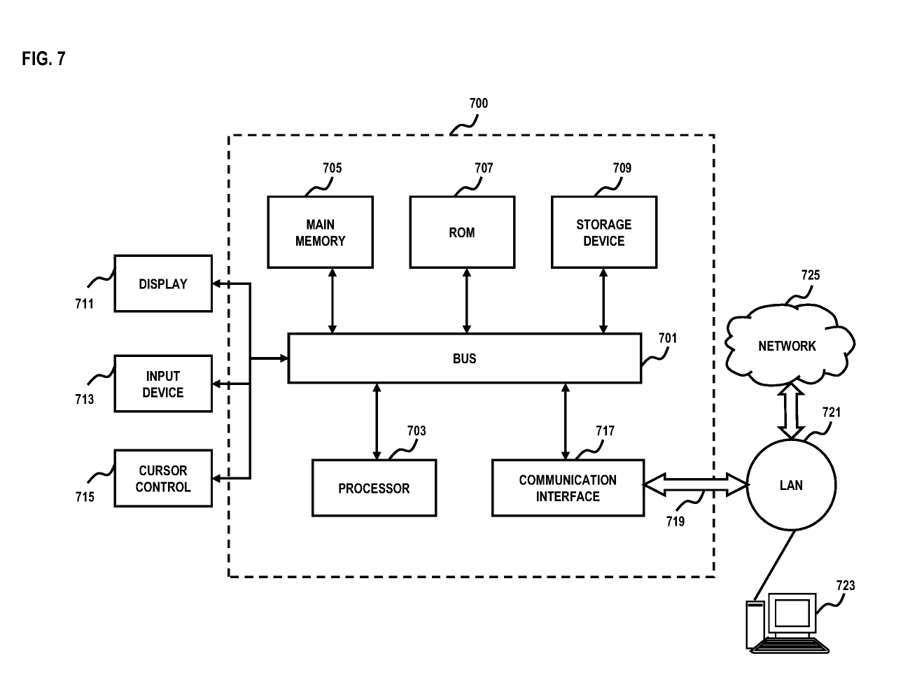

FIG. 2 is a diagram of a network resource manager, according to an exemplary embodiment. By way of example, network resource manager (or manager) 200 may comprise computing hardware (such as described with respect to FIG. 7), as well as include other components configured to execute the processes described herein. In an exemplary embodiment, manager 200 may be implemented as a rule-based system that utilizes rule-based business logic to obtain and analyze one or more metrics, such as one or more of those parameters stored to growth information repository 127, for the dynamic generation of growth notifications (e.g., growth notification 103) corresponding to service provider environment 105. As shown, manager 200 includes controller 201, growth management logic 203, growth notification module 205, growth information interface 207, portal interface 209, resource monitoring interface 211, resource ordering interface 213, and workforce management interface 215. It is contemplated, however, that manager 200 may embody many forms and include multiple and/or alternative components. For example, it is contemplated that the one or more components of manager 200 may be combined, located in separate structures, and/or separate physical locations. In other words, a specific topology is not critical to embodiments of manager 200 or system 100.

According to exemplary embodiments, growth management logic 203 provides administration tools for network resource growth management. For instance, a service provider may implement growth management logic 203 to establish and define one or more governing parameters and/or governing models to control the generation of growth notifications. These growth notifications may, in turn, be utilized to order and provision additional network resources to service provider environment 105. As such, growth management logic 203 may be used to define one or more growth notification trigger points (or threshold trigger points) for one or more network resources or groups of network resources, as well as one or more methodologies for determining how to manage (e.g., add) network resources to service provider environment 105 based on the issuance of at least one growth notification. Thus, growth management logic 203 may be utilized to establish when growth notifications are issued, as well as what, where, and how much additional network resources are required to be provisioned to service provider environment 105 to modify the utilization of network resources provisioned to service provider environment 105 according to another threshold, e.g., a relaxation threshold.

According to exemplary embodiments, the generation of a growth notification may be triggered based on the utilization of a network resource that is hierarchically associated with one or more other network resources. In this manner, the utilization of the network resource may also be employed to trigger growth notifications for one or more of the other network resources that are hierarchically related to the network resource. For example, if a network element (such as a routing cabinet) includes various place holders for supporting one or more shelves that, in turn, are capable of supporting one or more cards, which are associated with one or more ports, then the utilization of the ports may be assessed to selectively trigger growth notifications associated with the cards, shelves, and/or the network element. As such, growth notifications may be triggered and may specify additional network resources (e.g., cards, shelves, network elements, etc.) that are required to relieve an “exhausted” (or at least potentially exhausted) state of the ports, as those ports relate to the cards, shelves, network elements, etc.

It is noted that one or more network elements may also be physically (or logically) grouped into one or more network element groups. Accordingly, the utilization of the ports may also be assessed to trigger growth notifications for specifying additional network resources (e.g., network elements) that are required to relieve an “exhausted” (or at least potentially exhausted) state of a group of network elements or specifying a need to create one or more additional network element groups. Thus, growth management logic 203, via growth notification module 205, may trigger, generate, and issue growth notifications if the utilization of a network resource exceeds a first predetermined threshold (e.g., a threshold utilization trigger point) defining when the utilization of the network resource (due to, for instance, the support of one or more flows of network traffic) reaches a certain proscribed limit that is established based on a number of factors, such as an established exhaust threshold for a particular network resource, an assigned lead time for provisioning the particular network resource to service provider environment 105, and/or a utilization growth rate of the particular network resource.

Accordingly, growth management logic 203 may be configured to determine one or more exhaust thresholds, one or more lead-times, and one or more growth rates, as well as one or more threshold utilization trigger points. For instance, an exhaust threshold may be defined as a utilization amount corresponding to full utilization of a network resource, i.e., utilization of the network resource reaches 100% of its rated capacity, which may be defined by a network administrator, manufacturer of the network resource, or the like. As such, exhaust thresholds may be defined according to the type of network resource (e.g., network element group, network element, shelf, card, and port), as well as based on one or more other parameters that may characterize a network resource, e.g., supporting protocol, manufacturer, geographic implementation, etc. For instance, a port may be assigned based on a specific region of interest, geographical reach, etc. In such instances, the port may be treated as exhausted and, thereby, not available for other regions, geographies, etc., which may hold “true” even if utilization of the port is yet to reach its established exhaust threshold. As another example, a particular port may be an optical port. In such instances, the optical port may have a binary exhaust threshold, i.e., if the optical port is assigned and put in use, the optical port may then be considered exhausted, otherwise the optical port may be considered available.

To ensure sufficient quality of service, exhaust thresholds may, in exemplary embodiments, be established at lower levels of utilization than full utilization, e.g., any utilization level less than 100% of a rated capacity of a network resource. This enables network administrators to know when to stop provisioning new subscribers to the network resource so that network traffic of the existing subscribers already provisioned to the network resource may increase (or fluctuate) by the difference amount. For instance, a network administrator may establish an exhaust threshold for a particular port as 90% of its rated capacity. When utilization of the particular port reaches 90%, no more new subscribers may be provisioned to the port, such that network traffic of the existing subscribers may increase (or fluctuate) by the remaining 10% without requiring unnecessary infrastructure rearrangement, rerouting of network traffic or other like measures.

In exemplary embodiments, utilization of network resources may also be based on groupings of these network resources within a network element or network element group. For instance, all the ports or cards of a same type (e.g., Gigabit Ethernet, Optical Carrier-N, etc.) within a network element may be grouped, and an aggregate exhaust threshold established for these groupings. In this way, an exhaust threshold may be established as 95% utilization of the aggregated ports, etc., of a particular network element, such that the remaining 5% of the ports, etc., can be a margin (e.g., safety margin) for the utilization of these ports, etc, to increase, fluctuate, support emergency network traffic, etc.

It is also noted that exhaust thresholds may be established based on network resources that have been ordered but are yet to be provisioned to service provider environment 105. For example, if a number of cards, shelves, or network elements, have been ordered, groupings that would otherwise include these network resources may have their exhaust thresholds account for these yet to be provisioned network resources. This would prevent “extra” network resources from being ordered during a “lead time” period. Moreover, given the modular nature of typical network resources, exhaust thresholds may be established based on “possible” capacities to support additional network resources. For example, a network element group may be capable of supporting additional network elements than are “currently” provisioned to service provider environment 105. Meanwhile, the network elements may be capable of supporting additional shelves than are “currently” provisioned to the network elements. In turn, the shelves may be capable of supporting additional cards than are “currently” provisioned to these shelves. As such, exhaust thresholds may account for these “possible” capacities. Namely, exhaust thresholds may be established as if all the possible network resources that “could be” provisioned to a network element group, network element, or shelf are actually provisioned to the network element group, the network element, or the shelf.

Additionally, exhaust thresholds for “higher” hierarchical level network resources may be established based on utilization of “lower” hierarchical level network resources. For instance, utilization of network element groups, network elements, shelves, cards, and ports may be established based on utilization of the ports corresponding to each of these categories, e.g., all the ports of a card are considered to establish an exhaust threshold for the card, all the cards (and thereby ports) of a shelf are considered to establish an exhaust threshold for the shelf, and the like. Thus, exemplary exhaust thresholds may be established based on the parameters of Table 1.

TABLE 1

| Network | |
|---|---|
| Resource | Exhaust Threshold |
| Ports | Ports of a same type (e.g., Gigabit Ethernet, Optical Carrier- |
| | N, etc.) in a network element or group of network elements |
| | are grouped and an aggregate exhaust threshold is |
| | established for each of the groupings, e.g., 95% utilization of |
| | individual groupings of ports. |
| Cards | Ports of a card type (e.g., Gigabit Ethernet card, Optical |
| | Carrier-N card, etc.) in a network element or group of |
| | network elements, as well as previously ordered but yet to |
| | be provisioned cards of the network element or group of |
| | network elements, are grouped and an aggregate exhaust |
| | threshold is established for each of the groupings, e.g., 90% |
| | utilization of the groupings of corresponding ports. |
| | Also referred to as “Simple Exhaust” |
| Shelves | Ports of existing and previously ordered but yet to be |
| | installed shelves of a network element or group of network |
| | elements are grouped and an aggregate exhaust threshold for |
| | a possible capacity is established for each of the groupings, |
| | e.g., 80% utilization of the groupings of corresponding ports. |
| | Hence, utilization of shelves is established based on as if all |
| | the possible cards are installed and available. |
| | Also referred to as “Partial Exhaust” |
| Network | Ports of existing and previously ordered but yet to be |
| Elements | installed cards and shelves of a network element are grouped |
| | and an aggregate exhaust threshold for a possible capacity is |
| | established for the grouping, e.g., 70% utilization of the |
| | grouping of corresponding ports. Hence, utilization of a |
| | network element is established based on as if all the possible |
| | shelves and all the possible cards are installed and available. |
| | Also referred to as “Complete Exhaust” |
| Network | Ports of existing and previously ordered but yet to be |
| Element | installed cards, shelves, and network elements of a network |
| Groups | element group are grouped and an aggregate exhaust |
| | threshold for a possible capacity is established for the |
| | grouping, e.g., 70% utilization of the grouping of |
| | corresponding ports. Hence, utilization of a network |
| | element group is established based on as if all possible |
| | network elements, all possible shelves, and all possible cards |
| | are installed and available. |
| | Also referred to as “Composite Exhaust” |

As such, exhaust thresholds for the various network resources of service provider environment 105 may be stored to and, thereby, recalled from, growth information repository 127, a memory (not shown) of network resource manager 200, or any other suitable memory of system 100 via, for example, growth information interface 207.

In turn, lead times may define a period of time extending between the initiation of an ordering process for a new network resource and the completion of the provisioning of that network resource to service provider environment 105. Thus, a lead time may account for various factors that may affect how slowly or quickly a network resource may be provisioned to service provider environment 105, such as the ordering process, the manufacturing process, the shipping process, the installation process, the configuration process, the testing and debugging process, and the like. Accordingly, growth management logic 203 may assign uniform or varied lead times for various network resources that are (or may be capable of being) provisioned to service provider environment 105. It is also noted that these lead times may be fixed (e.g., established as a predetermined, resolute timeframe) or variable (e.g., established as a timeframe that may dynamically account for one or more of the aforementioned factors affecting lead times). Thus, growth management logic 203 may acquire various forms of information (e.g., manufacturing information, vendor information, workforce information, etc.) from network resource ordering system 119, workforce management system 123, vendor information repository 121, workforce information repository 125, and/or growth information repository 127, when assigning lead times for the various network resources. According to exemplary embodiments, workforce information may be acquired via workforce management interface 215 and vendor information may be acquired via resource ordering interface 213. As such, lead times may be stored to and, thereby, recalled from, growth information repository 127, a memory of network resource manager 200, or any other suitable memory of system 100 via, for example, growth information interface 207.

According to exemplary embodiments, growth management logic 203 may also determine one or more utilization growth rates for the various network resources of service provider environment 105 based on historical utilization growth rate information, nominal utilization growth rate information, and/or weighted historical utilization growth rate information. In this manner, utilization of the network resources of service provider environment 105 may be monitored by network resource monitoring system 115 over a predefined period of time, e.g., one or more years, months, weeks, days, etc. This information may be transmitted to network resource manager 200 via resource monitoring interface 211 and/or stored to growth information repository 127, a memory (not shown) of network resource manager 200, or any other suitable memory of system 100. In this way, the historical utilization growth rate information may relate to these “actually” monitored utilizations. Meanwhile, the nominal utilization growth rate information may relate to one or more hypothetical user inputs provided to network resource manager 200 via, for example, portal interface 209. As such, the nominal utilization growth rate information may be utilization information that is projected over one or more years, months, weeks, days, etc., by a network administrator. In turn, the weighted utilization growth rate information may relate to the historical utilization growth rate information influenced by projected utilization growth rate information provided as input to, for example, portal interface 209. If no available historical utilization growth rate information is available, static utilization growth rates may be assumed. In such instances, establishment of corresponding growth notification trigger points for particular network resources may be based only on an established exhaust threshold for the particular network resources and assigned lead times for provisioning the particular network resources to service provider environment 105. Since historical growth rate is unknown, the static growth trigger point can be set conservatively—i.e., set low.

Utilizing either the historical utilization growth rate information, the nominal utilization growth rate information, or the weighted utilization growth rate information, growth management logic 203 may trend or “best fit” the observed or speculated information to characterize a relationship between utilization of a particular network resource over a given time period or interval. According to exemplary embodiments, any suitable technique may be employed by growth management logic 203 to “best fit” the particular utilization growth rate information, such as any suitable linear or nonlinear regression analysis technique, e.g., method of least (error) squares, etc. For illustrative and simplicity purposes, however, utilization growth rate information is described with respect to “best fitting” a first order polynomial, i.e., a straight line.

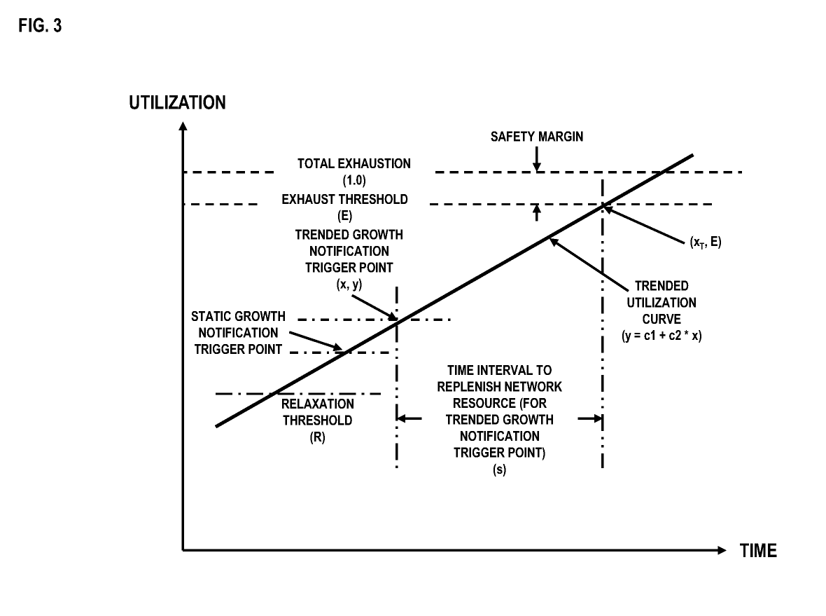

Once a suitable trend is established, growth management logic 203 may determine suitable growth notification trigger points for particular network resources by correlating established exhaust thresholds and assigned lead times to replenish the network resources with trended utilization growth rate information. This is illustrated in FIG. 3, i.e., a network resource utilization plot for establishing threshold trigger points for dynamically generating growth notifications, according to exemplary embodiments. Thus, by solving for a utilization corresponding to the trended growth notification trigger point of FIG. 3, growth management logic 203 may establish a threshold trigger point. Growth rate for each resource is computed, thus the coefficients would be different: C_{1c}, C_{2c}, C₁ₛ, C₂ₛ, etc. As shown below, Equations (1)-(4) define threshold trigger points for generating growth notifications for various exemplary network resources. Equations (1)-(4) may be defined as follows:

$$\begin{matrix}{y}_{c} = {c}_{1} + {c}_{2} * [ ( \frac{( {E}_{c} - {c}_{1} )}{{c}_{2}} ) - {s}_{c} ] & Eq . ( 1 ) \\ {y}_{s} = {c}_{1} + {c}_{2} * [ ( \frac{( {E}_{s} - {c}_{1} )}{{c}_{2}} ) - {s}_{s} ] & Eq . ( 2 ) \\ {y}_{n} = {c}_{1} + {c}_{2} * [ ( \frac{( {E}_{n} - {c}_{1} )}{{c}_{2}} ) - {s}_{n} ] & Eq . ( 3 ) \\ {y}_{g} = {c}_{1} + {c}_{2} * [ ( \frac{( {E}_{g} - {c}_{1} )}{{c}_{2}} ) - {s}_{g} ] & Eq . ( 4 )\end{matrix}$$

where:

y_{c}=Growth Notification Trigger Point for Cards Exhaust

yₛ=Growth Notification Trigger Point for Shelves Exhaust

yₙ=Growth Notification Trigger Point for Network Element Exhaust

y_{g}=Growth Notification Trigger Point for Network Element Group Exhaust

E_{c}=Cards Exhaust Threshold Value

Eₛ=Shelves Exhaust Threshold Value

Eₙ=Network Element Exhaust Threshold Value

E_{g}=Network Element Group Exhaust Threshold Value

s_{c}=Lead Time to Replenish Cards

sₛ=Lead Time to Replenish Shelves

sₙ=Lead Time to Replenish Network Element

s_{g}=Lead Time to Replenish Network Element Group

c₁=Predetermined Coefficients, C_{1c}, C₁ₛ, etc.

c₂=Predetermined Coefficients, C_{2c}, C₂ₛ, etc.

Accordingly, by monitoring (or otherwise determining) utilization of a particular network resource that is hierarchically associated with one or more other network resources, growth notification module 205 may trigger a growth notification (e.g., growth notification 103) if the utilization of the particular network resource exceeds a first predetermined threshold, e.g., a threshold trigger point. In exemplary embodiments, network resource monitoring may be implemented by, for example, network resource monitoring system 115 that collects and stores various utilization information (e.g., network resource usage statistics) to utilization information repository 117. It is noted that network resource monitoring system 115 may gather (or receive) such utilization information from various strategically deployed network traffic analyzers or from the network resources of service provider environment 105. It is also noted that monitoring may be performed continually, periodically (e.g., every one or more minutes, hours, days, weeks, etc.), or in an on-demand fashion. Accordingly, utilization information may be received by resource monitoring interface 211, discriminately parsed, and analyzed to determine whether utilization of one or more network resources exceeds correspondingly established threshold trigger points. As previously described, this utilization information may correspond to the utilization of one or more ports, which may be hierarchically ordered based on port association with one or more hierarchical levels.

Accordingly, growth management logic 203, growth notification module 205, and/or resource monitoring interface 211 may determine a “current” utilization of a particular resource based on utilization information. Equations (5)-(13) define “current” utilizations for various exemplary network resources, and may be defined as follows:

$$\begin{matrix}{U}_{c - current} = \frac{{p}_{exh}}{{p}_{inscard}} & Eq . ( 5 ) \\ {U}_{s - current} = \frac{{p}_{exh}}{{p}_{insshelf}} & Eq . ( 6 ) \\ {U}_{n - current} = \frac{{p}_{exh}}{{p}_{insNE}} & Eq . ( 7 ) \\ {U}_{g - current} = \frac{{p}_{exh}}{{p}_{insG}} \\ where \text{:} & Eq . ( 8 ) \\ {p}_{exh} = [ {\sum }_{j = 1}^{j = {e}_{ins}} {( {s}_{ins} )}_{j} ] * [ {\sum }_{k = 1}^{k = {( {s}_{ins} )}_{j}} {( {c}_{ins} )}_{j , k} ] * [ {\sum }_{l = 1}^{l = {( {c}_{ins} )}_{j , k}} {( {p}_{exh} )}_{j , k , l} ] & Eq . ( 9 ) \\ {p}_{inscard} = [ {\sum }_{j = 1}^{j = {e}_{ins}} {( {s}_{ins} )}_{j} ] * [ {\sum }_{k = 1}^{k = {( {s}_{ins} )}_{j}} {( {c}_{ins} )}_{j , k} ] * [ {\sum }_{l = 1}^{l = {( {c}_{ins} )}_{j , k}} {( p )}_{j , k , l} ] & Eq . ( 10 ) \\ {p}_{insshelf} = [ {\sum }_{j = 1}^{j = {e}_{ins}} {( {s}_{ins} )}_{j} ] * [ {\sum }_{k = 1}^{k = {( {s}_{ins} )}_{j}} {( {c}_{max} )}_{j , k} ] * [ {\sum }_{l = 1}^{l = {( {c}_{max} )}_{j , k}} {( p )}_{j , k , l} ] & Eq . ( 11 ) \\ {p}_{insNE} = [ {\sum }_{j = 1}^{j = {e}_{ins}} {( {s}_{max} )}_{j} ] * [ {\sum }_{k = 1}^{k = {( {s}_{max} )}_{j}} {( {c}_{max} )}_{j , k} ] * [ {\sum }_{l = 1}^{l = {( {c}_{max} )}_{j , k}} {( p )}_{j , k , l} ] ; \\ for {e}_{ins} = 1 & Eq . ( 12 ) \\ {p}_{insG} = [ {\sum }_{j = 1}^{j = {e}_{ins}} {( {s}_{max} )}_{j} ] * [ {\sum }_{k = 1}^{k = {( {s}_{max} )}_{j}} {( {c}_{max} )}_{j , k} ] * [ {\sum }_{l = 1}^{l = {( {c}_{max} )}_{j , k}} {( p )}_{j , k , l} ] ; \\ for {e}_{ins} \geq 1 & Eq . ( 13 )\end{matrix}$$

where:
U_{c-current}=Cards Utilization at a Particular Time
U_{s-current}=Shelves Utilization at a Particular Time
U_{n-current}=Network Element Utilization at a Particular Time
U_{g-current}=Network Element Group Utilization at a Particular Time
eₘₐₓ=Maximum Number of Network Elements in a Network
(sₘₐₓ)ₑ=Maximum Number of Shelves in a Network Element; Varies According to Particular Network Element
(cₘₐₓ)_{e,s}=Maximum Number of Cards in a Shelf; Varies According to Particular Network Element and Particular Shelf
(p)_{e,s,c}=Number of Ports in a Card; Varies According to Particular Network Element, Particular Shelf, and Particular Card
eᵢₙₛ=Number of Network Elements Installed and in Order
(sᵢₙₛ)ₑ=Number of Shelves Installed and in Order in each Network Elements
(cᵢₙₛ)_{e,s}=Number of Cards Installed and in Order in each Network Element and in each Shelf
pₑₓₕ=Number of Ports Exhausted in Installed Cards in all Network Elements
p_{inscard}=Number of Ports in Installed and Ordered Cards in all Network Elements
p_{insshelf}=Maximum Number of Ports Possible with Installed and Ordered Shelves Assuming all Cards of Required Type are Installed
p_{insNE}=Maximum Number of Ports Possible with Installed and Ordered Network Elements Assuming all Shelves and Cards of Required Type are Installed
p_{insG}=Maximum Number of Ports Possible with Installed and Ordered Network Elements Groups Assuming all Shelves, Cards, and Network Elements of Required Type are Installed

Thus, growth management logic 203 and/or growth notification module 205 may correlate, e.g., compare, “current” utilizations of the network resource provisioned to service provider environment 105 with correspondingly established growth notification trigger points for these network resources in order to determine whether to issue one or more growth notifications (e.g., growth notification 103). It is to be noted that these correlations may be performed continuously, periodically (e.g., weekly, daily, hourly, etc.), or in an on-demand fashion. Equations (14)-(17) provide correlation points for triggering growth notifications. Namely, if one or more of Equations (14)-(17) hold “true,” then a corresponding growth notification may be generated and issued to, for example, a network administrator at a client computing device, e.g., client computing device 111n. Equations (14)-(17) may be defined as follows:

If

U_{c-current}≧y_{c} Eq. (14)
Then Cards Exhaust Trigger Point Reached Issue Growth Notification for Cards

If

U_{s-current}≧yₛ Eq. (15)
Then Shelves Exhaust Trigger Point Reached Issue Growth Notification for Shelves

If

U_{n-current}≧yₙ Eq. (16)
Then Network Element Exhaust Trigger Point Reached Issue Growth Notification for Network Element

If

U_{g-current}≧y_{g} Eq. (17)
Then Network Element Group Exhaust Trigger Point Reached Issue Growth Notification for Network Element Group

where:
U_{c-current}=Cards Utilization at a Particular Time
U_{s-current}=Shelves Utilization at a Particular Time
U_{n-current}=Network Element Utilization at a Particular Time
U_{g-current}=Network Element Group Utilization at a Particular Time
y_{c}=Growth Notification Trigger Point for Cards Exhaust (Alignment)
yₛ=Growth Notification Trigger Point for Shelves Exhaust (Alignment)
yₙ=Growth Notification Trigger Point for Network Element Exhaust (Alignment)
y_{g}=Growth Notification Trigger Point for Network Element Group Exhaust (Alignment)

According to exemplary embodiments, if a growth notification is to be issued, growth management logic 203 and/or growth notification module 205 may also determine one or more resource quantities that may be ordered and provisioned to service provider environment 105 in order to modify a utilization of a particular network resource according to a second predetermined threshold. This second threshold is a relaxation threshold and may be established lower than the growth notification trigger point for a particular resource (or a group of resources). Growth management logic 203 and/or growth notification module 205 may determine one or more additional network resources required when trigger by a corresponding growth notification trigger point. This quantity may be such that when a utilization of a particular resource reaches a corresponding exhaust threshold established for the resource, an ordered quantity that arrives and is installed, would cause the utilization of the resource to decrease to an established relaxation threshold for the resource. A relaxation threshold for a given resource (or group of given resources) is defined in Equation (18) as follows:

Rᵣ=Cᵣ*yᵣ Eq. (18)

where:
Rᵣ=Relaxation Threshold Value for a Given Resource (or Group of Resources)
yᵣ=Growth Notification Trigger Point at Which an Ordering Process is to Start for a Given Resource (or Group of Given Resources)
Cᵣ=Predetermined Relaxation Factor for a Given Resource (or Group of Given Resources)−(Cᵣ may Always be <1)
r=Resource, e.g., Card, Shelf, Network Element, or Network Element Group

Thus, when network resource quantities are being determined for a particular network resource based on the triggering of a growth notification, a time shift may be “pretended” (i.e., a time shift may be simulated to a “future” time) such that the pretended time may be a time at which point the utilization of a particular network resource reaches exhaustion and a required quantity is not yet ordered at the time of the growth notification. Accordingly, for any given network resource, Equation (19) may be defined as follows:

Uᵣ=Eᵣ Eq. (19)

where:
Uᵣ=Utilization Level for a Given Resource (or Group of Given Resources) at Time of Resource Exhaustion
Eᵣ=Exhaust Threshold Value for a Given Resource (or Group of Given Resources)

Since utilization may also be defined in terms of exhausted network interface ports corresponding to the particular resource, Equation (19) may also be defined in Equation (20) as follows:

$${U}_{r} = \frac{{p}_{exh}}{{p}_{insR}} \qquad Eq . ( 20 )$$

where:
Uᵣ=Utilization Level for a Given Resource (or Group of Given Resources) at Time of Resource Exhaustion
pₑₓₕ=Number of Exhausted Ports that Cause a Given Resource (or Group of Given Resources) to Become Exhausted
p_{insR}=Maximum Number of Possible Ports with the Installed and Ordered Quantity for a Given Resource (or Group of Given Resources)

Once one or more required quantities of network resources are determined, network resource ordering system 119 may, for example, order these required quantities from one or more vendors. In this manner, growth management logic 203 and/or growth notification module 205 may determined a new (e.g., updated) p_{insR} for each given resource affected. In this manner, Equations (10)-(13) may be updated such that a required quantity of a particular resource can cause a “current” utilization Uᵣ, which is “pretended” to be equal to Eᵣ, to decrease to a corresponding relaxation threshold Rᵣ for the particular resource. Accordingly, these determined quantities are the quantities of network resources that are to be ordered at the time of a growth notification for the various network resources (or groups of network resources) affected.

Thus, utilizing Equations (19) and (20), growth management logic 203 and/or growth notification module 205 may determine and specify in an issued growth notification (e.g., growth notification 103), additional network resources required so that at a time of resource exhaustion, an ordered quantity is in place so as to relax the one or more “current” utilizations to be below one or more predetermined relaxation thresholds for the one or more network resources. It is noted that when ports become exhausted, additional cards may be ordered and provisioned to service provider environment 105 to relax a “current” utilization of the ports. As for the other exemplary network resources, e.g., cards, shelves, network elements, or groups of network elements, additional ones of these network resources may be ordered and provisioned to service provider environment 105 to relax a “current” utilization of these network resources.

In a typical scenario, threshold trigger points for cards will exhaust first, thereby triggering growth notification(s) for additional cards. As more and more cards are provisioned to service provider environment 105, an established threshold trigger point for shelves of a network element can be reached, thereby triggering growth notification(s) for additional shelves. Once new shelves are provisioned to service provider environment 105, the exhaustion of shelves would be relaxed and, again, the exhaustion of cards would eventually occur. This would be an iterative cycle until a threshold trigger point for a network element is reached, thereby triggering growth notification(s) for additional network elements. These additional network elements may be provisioned as standalone network resources or many be provisioned to one or more network element groups. Again, the exhaustion of cards, shelves, and network elements, would carry along an iterative sequence until the exhaustion of a network element group occurred, thereby triggering growth notification(s) for additional network element groups. Again, the exhaustion of the network resources provisioned to service provider environment 105 would iterate between the cards, the shelves, the network elements, and the network element groups.

Service providers also typically engage in network modeling exercises in order to forecast network growth. Modeling enables carriers to consider a status quo situation and compare one or more alternative scenarios. Comparative results can then be produced and alternate options can be ranked in terms of attractiveness to the carrier. According to exemplary embodiments, network resource manager 200 may also include portal interface 209 to enable users (e.g., network administrators) to perform network modeling exercises based on one or more “hypothetical” network growth scenarios. Namely, these users via, for example, one or more client computing devices 111a-111n, may input and, thereby, adjust various parameters, e.g., exhaust thresholds, utilization growth rate information, lead times, relaxation thresholds, trigger point thresholds, etc., to conduct the aforementioned “what if” planning. One or more graphical user interfaces may be provided via portal interface 209 for this purpose.

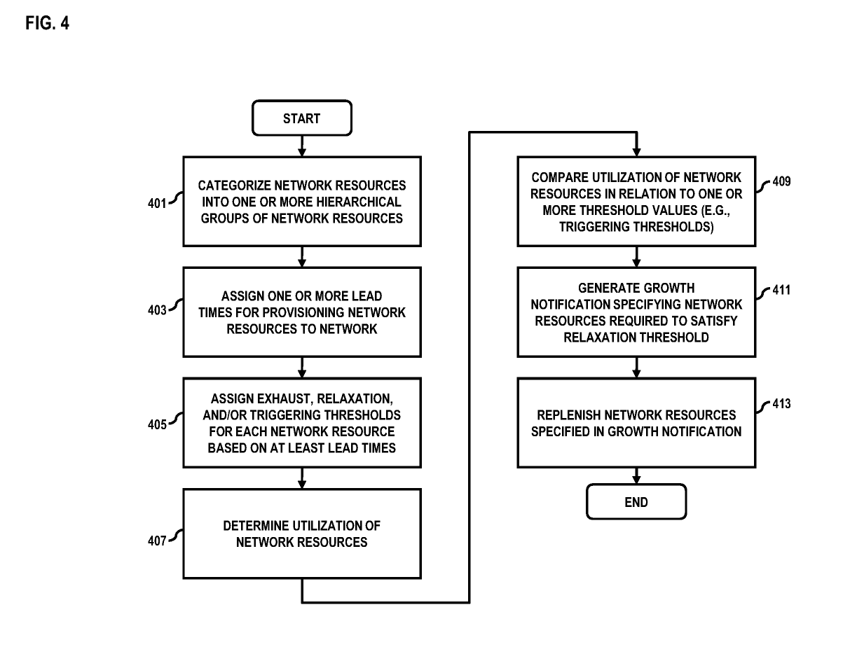

FIG. 4 is a flowchart of a process for managing network resources based on dynamically generated growth notifications, according to an exemplary embodiment. For illustrative purposes, the process is described with reference to FIGS. 1 and 2. It is also noted that the steps of the process may be performed in any suitable order, as well as combined or separated in any suitable manner. Moreover, for the process described with respect to particular network resources, i.e., network element groups, network elements, shelves, cards, and ports; however, it is contemplated that the process may be applied to any suitable number or type of network resources. At step 401, network resource manager 200, i.e., growth management logic 203, categorizes the network resources (e.g., network element groups, network elements, shelves, cards, ports, etc.) of service provider environment 105 into one or more hierarchical groups of network resources. Categorization of these resources may be performed based on information (e.g., network topology, network resource inventory, hierarchical levels, hierarchical categorizations, etc.) stored to growth information repository 127, a memory (not shown) of network resource manager 200, or based on input provided by, for example, a network administrator via portal interface 209. According to exemplary embodiments, the top most hierarchy of network resources is the equipment, i.e., the network elements. However, since a group of network elements may serve the same function and/or share network traffic among them, such groupings may, at times, occupy a highest level in the hierarchy followed by the individual network elements that the group encompasses. It is noted that such groupings may be logical and/or physical. Since most network elements are modular in design and, thereby, capable of supporting the provisioning of additional modules as and when utilization of the network element increases, a next lower hierarchical level may include the various modular sub-elements. For instance, the shelves of a network element may be categorized to this hierarchical level. Typically the shelves of a network element include one or more slots that may be filled by the actual components that interface with the transmission lines of a network, e.g., the cards. As such, a next lower level of the network resource hierarchy may be the cards. It is noted that individual cards may occupy one or more slots or even one or more shelves. Thus, by considering the size of individual cards provisioned to the shelves, the slots of the shelves may be indirectly taken into account. As such, the slots need not be directly considered; however, may be added to the hierarchy if desired. A lowest level of the hierarchy may be the physical or logical points of connection in the cards for the transmission lines of service provider network 105, i.e., the various ports of the cards. It is noted that the cards of service provider environment may support many different types of network traffic and, therefore, may include ports of a single type or of multiple types, e.g., physical or logical, analog or digital, electrical or optical, wired or wireless, and the like. At any rate, since the ports of a card occupy a lowest level of the hierarchy of network resources, the ports may provide a baseline from which consideration of the other hierarchical levels and, thereby, network resources may be determined.

Once a suitable hierarchy is established, growth management logic 203 may assign, in step 403, one or more lead times for provisioning additional network resources to service provider environment 105. In establishing lead-times, growth management logic 203 may acquire various forms of information (e.g., manufacturing information, vendor information, workforce information, etc.) from network resource ordering system 119, workforce management system 123, vendor information repository 121, workforce information repository 125, and/or growth information repository 127 via growth information interface 207, resource ordering interface 213, workforce management interface 215, and/or portal interface 209. In exemplary embodiments, assigned lead times may be stored to growth information repository 127, a memory of network resource manager 200, or any other suitable memory of system 100.

Per step 405, growth management logic 203 may assign one or more thresholds (e.g., one or more exhaust thresholds, one or more relaxation thresholds, one or more triggering thresholds, etc.) for each of the network resources and/or groups of network resources provisioned to service provider environment 105. As will be explained in more detail below, these thresholds can be utilized to govern the generation of growth notifications (e.g., growth notification 103) by growth notification logic 203 and growth notification module 205. In exemplary embodiments, each of these thresholds may relate to utilization amounts (e.g., network traffic loads at a particular point in time or over a particular period of time) for the network resources. Exemplary exhaust thresholds may be established as previously described with respect to FIG. 3. Establishment of trigger point thresholds and relaxation thresholds are more fully explained below.

According to exemplary embodiments, a trigger point threshold may be defined as a utilization amount that when reached, a growth notification for a particular resource is to be issued by, for example, growth management logic 203 and/or growth notification module 205. As such, one or more threshold utilization trigger points may be established by growth management logic 203 based on one or more factors of a particular network resource, such as an established exhaust threshold for the particular network resource, an assigned lead time for provisioning the particular network resource to service provider environment 105, and/or a growth rate for utilization of the particular network resource. In exemplary embodiments, determination of these trigger points is based on aforementioned Equations (1)-(4). In turn, relaxation thresholds may be defined as any suitable utilization amount below which a threshold utilization trigger point is established. Relaxation thresholds may be defined based on the business judgment of a network administrator, but may also be determined by growth management logic 203 based on the available resources of a service provider to order and provision additional network resources to service provider environment 105. For instance, the lower the relaxation threshold is established, the more additional network resources are required to modify the utilization of a particular network resource below the relaxation threshold. In turn, larger monetary expenditures may be required, as well as greater numbers of workers and equipment to provision these additional network resources. At a complementary end, the closer the relaxation threshold is established to a threshold utilization trigger point, the more often additional network resources will be required to be ordered for and provisioned to service provider environment 105. This also may cause larger monetary expenditures due to increased shipping fees, sending and resending workers to provision additional network resources to service provider environment 105, and the like. Thus, in exemplary embodiments, growth management logic 203 may optimize relaxation thresholds to prevent the unnecessary expenditure of capital by a service provider. At the same time, optimization may also ensure subscribers receive suitable levels of quality of service. In this manner, established exhaust thresholds, relaxation thresholds, and/or trigger point thresholds may be stored to growth information repository 127, a memory of network resource manager 200, or any other suitable memory of system 100. These thresholds may additionally (or alternatively) be ported to growth notification module 205 for triggering the generation and issuance of one or more growth notifications, such as growth notification 103.

At step 407, network resource manager 200 (e.g., growth notification module 205) determines utilization of the various network resources provisioned to service provider environment 105. In doing so, utilization information may be ported to growth notification module 205 via resource monitoring interface 211. This may occur under real-time or non-real-time conditions. Furthermore, the utilization information may be ported to growth notification module 205 continuously, periodically, or in an on-demand fashion. Based on the received utilization information, growth notification module 205 may determine utilization of the various network resources according to aforementioned Equations (5)-(13). Per step 409, each determined utilization may be compared in relation to one or more corresponding thresholds (e.g., trigger point thresholds) that, as previously mentioned, may be established based on one or more other thresholds (e.g., exhaust thresholds), one or more lead times, and/or one or more utilization growth rates established for the network resources provisioned to service provider environment 105. Comparisons may be performed according to aforementioned Equations (14)-(17). Based on these comparisons, growth notification module 205 may, in step 411, generate one or more growth notifications (e.g., growth notification 103) specifying one or more additional network resources required to modify these utilizations according to one or more other thresholds (e.g., relaxation thresholds). Determination of a required amount of additional network resources may be performed according to aforementioned equations (18)-(20). Thus, the network resources specified in the one or more growth notifications may be replenished, per step 413. That is, the additional network resources specified in the one or more growth notifications may be ordered and provisioned to service provider environment 105.

In some instances, the growth rate for particular network resources may decrease, such as in response to a business rule or decision, e.g., rearrangement of the infrastructure of, for example, service provider environment 105, changes to the business model of a service provider, etc. According to exemplary embodiments, such decreases in the growth rate may result in raising one or more thresholds (e.g., trigger point thresholds) for one or more network resources provisioned to service provider environment 105. As such, a “previously” issued growth notification may be required to be withdrawn because a “current” utilization of network resources may be below “newly” established threshold trigger points.

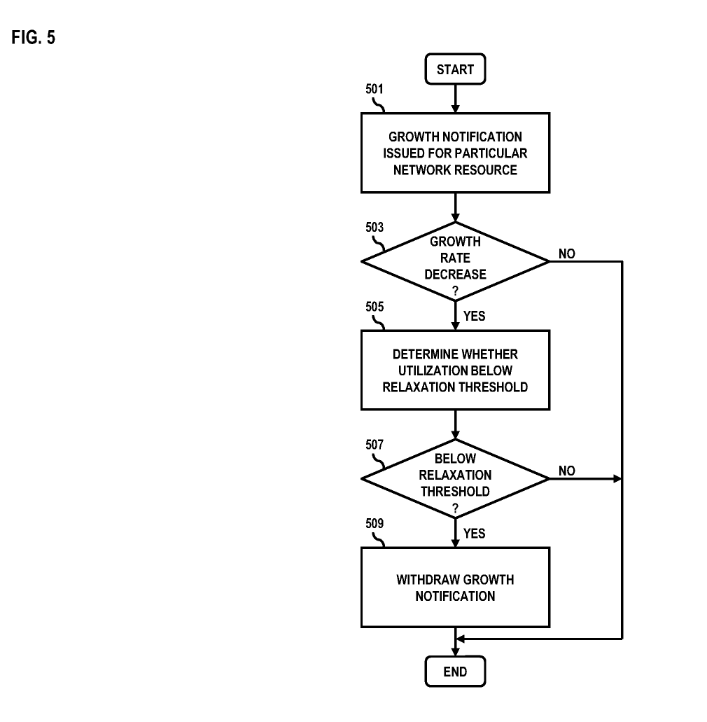

FIG. 5 is a flowchart of a process for withdrawing growth notifications, according to an exemplary embodiment. For illustrative purposes, the process is described with reference to FIGS. 1 and 2. It is also noted that the steps of the process may be performed in any suitable order, as well as combined or separated in any suitable manner. At step 501, a growth notification 103 is issued for a particular network resource, such as in response to the process of FIG. 4. Per step 503, growth notification module 205 determines whether a growth rate for the particular network resource has decreased, such as in response to a business decision of a service provider of service provider environment 105. In exemplary embodiments, growth notification module 205 may be automatically signaled to perform step 503 upon the rearrangement of the infrastructure of, for example, service provider environment 105, changes to the business model of the service provider, or other like business decisions of the service provider. Additionally (or alternatively), determination of a decrease in the growth rate may be performed in response to a change in information stored to growth information repository 127 or based on a request by a network administrator via portal interface 209. If the growth rate for the particular network resource has not decreased, then the process ends and previously issued growth notification 103 will remain valid. If the growth rate for the particular network element did decrease, then growth notification module 205 determines, per step 505, whether utilization of the particular network resource is below an established relaxation threshold for the particular network resource. If, in step 507, the utilization is not below the relaxation threshold, then the process ends and previously issued growth notification 103 will remain valid. This prevents the abrupt withdrawal of growth notification 103 that may be subsequently issued in a short period thereafter. If, in step 507, the utilization is below the relaxation threshold, then growth notification 103 is withdrawn, per step 509.

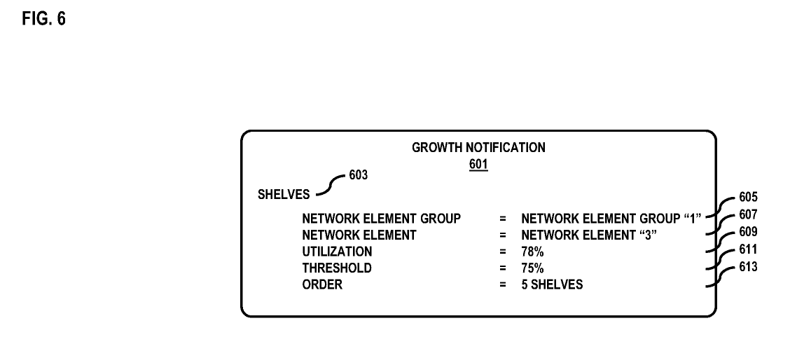

FIG. 6 is a diagram of an illustrative growth notification, according to an exemplary embodiment. As shown, growth notification 601 provides a growth notification for the shelves of a particular network element group. In this manner, growth notification 601 provides a region 603 (e.g., a section, or portion of a growth notification layout, or attributes in a growth notification) for specifying a network resource for which the growth notification is applicable. Regions 605 and 607 respectively indicate a network element group, i.e., “NETWORK ELEMENT GROUP ‘1,’” and a network element, i.e., “NETWORK ELEMENT ‘3,’” for which utilization of the resource specified in region 603 is beyond a threshold trigger point. According to exemplary embodiments, a “current” utilization of the network resource is specified in region 609, while a predefined threshold utilization trigger point for the network resource is specified in region 611. Region 613 may specify one or more additional resources, e.g., “5 SHELVES,” that are required to modify the “current” utilization of the network resource of region 603, such as to modify the “current” utilization below a relaxation threshold.

The processes described herein for network resource growth management may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 7 illustrates computing hardware (e.g., computer system) 700 upon which an embodiment according to the invention can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining utilization of a network resource that is hierarchically associated with one or more other network resources; and
triggering a growth notification if the utilization exceeds a first predetermined threshold,
wherein the growth notification specifies additional network resources required to modify the utilization of the network resource according to a second predetermined threshold.

2. A method according to claim 1, further comprising:
establishing the first predetermined threshold based on a rated capacity for the network resource and a lead-time for replenishing the network resource.

3. A method according to claim 2, wherein the step of establishing is further based on a utilization growth rate for the network resource or a geographical reach of the network resource.

4. A method according to claim 1, wherein the step of determining is performed on a continual basis, periodic basis, or on-demand basis.

5. A method according to claim 1, further comprising:
provisioning, in response to the growth notification, the additional network resources; and
establishing a new first predetermined threshold based on the provisioning step.

6. A method according to claim 1, further comprising:
establishing a new first predetermined threshold in response to a business decision; and
withdrawing the growth notification if the utilization is less than both the new first predetermined threshold and the second predetermined threshold,
wherein the business decision relates to rearrangement of an infrastructure supporting the network resource or changes to a business model.

7. A method according to claim 1, wherein the network resource is a network interface port, a network interface card, a shelf of a network element, a network element, or a group of network elements.

8. A method according to claim 1, wherein the network resource relates to a lowest hierarchical level, the method further comprising:
grouping the network resource to a plurality of network resources of the lowest hierarchical level in relation to another network resource of a higher hierarchical level;
determining another utilization of the other network resource based on utilization of the plurality; and
triggering another growth notification if the other utilization exceeds another first predetermined threshold,
wherein the other first predetermined threshold is defined in terms of utilization of the plurality.

9. An apparatus comprising:
a processor configured to determine utilization of a network resource that is hierarchically associated with one or more other network resources and to trigger a growth notification if the utilization exceeds a first predetermined threshold,
wherein the growth notification specifies additional network resources required to modify the utilization of the network resource according to a second predetermined threshold.

10. An apparatus according to claim 9, further comprising:
a communication interface configured to issue the growth notification to a client device accessible over one or more communication networks.

11. An apparatus according to claim 9, wherein the processor is further configured to establish the first predetermined threshold based on a rated capacity for the network resource and a lead-time for replenishing the network resource.

12. An apparatus according to claim 11, wherein the processor is further configured to establish the first predetermined threshold based on a utilization growth rate for the network resource or a geographical reach of the network resource.

13. An apparatus according to claim 9, wherein the processor is further configured to determine the utilization on a continual basis, periodic basis, or on-demand basis.

14. An apparatus according to claim 9, wherein the communication interface is further configured to transmit an order, in response to the growth notification, for the additional network resources, and the processor is further configured to establish a new first predetermined threshold based on the order.

15. An apparatus according to claim 9, wherein the processor is further configured to establish a new first predetermined threshold in response to a business decision and to withdraw the growth notification if the utilization is less than both the new first predetermined threshold and the second predetermined threshold, wherein the business decision relates to rearrangement of an infrastructure supporting the network resource or changes to a business model.

16. An apparatus according to claim 9, wherein the network resource is a network interface port, a network interface card, a shelf of a network element, a network element, or a group of network elements.

17. An apparatus according to claim 9, wherein the network resource relates to a lowest hierarchical level, the processor being further configured to group the network resource to a plurality of network resources of the lowest hierarchical level in relation to another network resource of a higher hierarchical level, determining another utilization of the other network resource based on utilization of the plurality, and trigger another growth notification if the other utilization exceeds another first predetermined threshold, the other first predetermined threshold being defined in terms of utilization of the plurality.

18. A system comprising:
a network element including a plurality of resources grouped to one or more hierarchical levels;
a monitoring module configured to determine a utilization of each hierarchical level; and
a growth notification module configured to trigger a growth notification if a particular utilization of a particular hierarchical level exceeds a corresponding first threshold for the particular hierarchical level,
wherein the growth notification specifies additional network resources required to modify the particular utilization according to a second threshold.

19. A system according to claim 18, wherein the first threshold is established based on a rated capacity for resources grouped to the particular hierarchical level, a lead-time for replenishing resources grouped to the particular hierarchical level, and a utilization growth rate for the resources grouped to the particular hierarchical level.

20. A system according to claim 19, further comprising:
a portal configured to receive input from a user for affecting the first threshold,
wherein the growth notification module is configured to withdraw the growth notification if the utilization is less than both the affected first threshold and the second threshold.
